(19) United States
(12) Patent Application Publication
(10) Pub. No.: US 2015/0218367 A1
(43) Pub. Date: Aug. 6, 2015

(54) EXTRUDABLE COMPOSITION DERIVED FROM RENEWABLE RESOURCES

(71) Applicant: EARTH RENEWABLE TECHNOLOGIES, Brevard, NC (US)

(72) Inventors: Richard Peter Scalzo, Brevard, NC (US); James Etson Brandenburg, Greer, SC (US); Marvin Lynn Mitchell, Parker, CO (US); Paula Hines Mitchell, Parker, CO (US); Melvin Glenn Mitchell, Penrose, NC (US); Cynthia Gail Mitchell, Penrose, NC (US); Thomas Jason Wolfe, Brevard, NC (US); Amber Layne Wolfe, Brevard, NC (US)

(21) Appl. No.: 14/422,332

(22) PCT Filed: Sep. 24, 2013
(86) PCT No.: PCT/US13/61373

§ 371 Date: Feb. 18, 2015

Related U.S. Application Data
(63) Continuation of application No. 13/790,889, filed on Mar. 8, 2013.
(60) Provisional application No. 61/705,683, filed on Sep. 26, 2012.
(60) Provisional application No. 61/726,188, filed on Nov. 14, 2012.
(60) Provisional application No. 61/844,155, filed on Jul. 9, 2013.

(51) Int. Cl. C08L 67/04; B29C 49/00; B29C 45/00

(52) U.S. Cl. CPC C08L 67/04; B29C 45/0001; B29C 49/0005; C08L 2205/03; C08L 2203/10; C08L 2205/06; C08L 2201/06; B29K 2835/00; B29L 2031/7158

(57) ABSTRACT

The extrudable composition may be an extrudable composition having a heat deflection temperature greater than about 50° C. and a melting point between about 80° C. to about 190° C., the extrudable composition includes about 60 to about 99.8% partially crystalline or crystalline polylactic acid, about 0.05 to about 8% cyclodextrin, about 0.1 to about 8% natural oil, fatty acid, fatty acid ester, wax or waxy ester, about 0.01 to about 5% nanofibers, about 0 to about 10% crystallinity agent, about 0 to about 1% starch-based melt rheology modifier, about 0 to about 5% colorant, about 0 to about 1% plasticizer, about 0 to about 1% gloss agent, and about 0 to about 1% barrier agent.

### CROSS-RELATED APPLICATION DATA

This application claims priority to U.S. Provisional Application Ser. No. 61/705,683; filed Sep. 26, 2012, U.S. Provisional Application Ser. No. 61/726,188; filed Nov. 14, 2012, U.S. Provisional Application 61/844,155; filed Jul. 9, 2013, and is a continuation-in-part of U.S. application Ser. No. 13/790,889; filed Mar. 8, 2013, the disclosures of which are incorporated herein by reference in their entirety.

### FIELD OF THE INVENTION

The present invention relates to an extrudable composition and a method of making molded articles therefrom. The extrudable composition includes a polylactic acid polymer derived from a renewable resource and the composition is biodegradable.

### BACKGROUND OF THE INVENTION

Molded articles are typically formed from various extrudable polymer compositions and exemplary articles of manufacture include bottles and other food containers, films, packaging, and the like. In the past such molded articles were formed from petroleum-based polymers which typically are neither derived from a renewable resource nor biodegradable. Exemplary petroleum-based polymers include polypropylene (PP), polyethylene terephthalate (PET), polystyrene (PS), and polyvinylchloride (PVC). Such petroleum-based polymers not only are environmentally unfriendly but the solvents and methods for making such polymers are also environmentally unfriendly. Moreover although some of these polymers may be recyclable, they are not biodegradable and pose problems in landfills and the like.

A solution to this problem is to form molded articles from a polymer that is derived from a renewable resource. An example of such a polymer that is derived from a renewable resource is polylactic acid (PLA). PLA is derived from various natural renewable resource material such as corn, plant starches (e.g., potatoes), and canes (e.g., sugar cane). Such efforts to utilize PLA are described in, for example, U.S. Publication Nos. 2011/005847A1 and 2010/0105835A1, PCT Publication No. WO 2007/047999A1, and U.S. Pat. Nos. 5,744,510, 6,150,438, 6,756,428, and 6,869,985, the disclosures of which are incorporated by reference in their entireties. For purposes of this disclosure, the term ‘lactide-based polymer’ is intended to by synonymous with the terms polylactide, polylactic acid (PLA) and polylactide polymer, and is intended to include any polymer formed via the ring opening polymerization of lactide monomers, either alone (i.e., homopolymer) or in mixture or copolymer with other monomers. The term is also intended to encompass any different configuration and arrangement of the constituent monomers (such as syndiotactic, isotactic, amorphosis, crystalline, partially crystalline, and the like). The lactide-based polymer may or may not be derived from a renewable resource.

PLA is formed by the ring-opening polymerization of lactide. PLA is a crystalline polymer and thus has challenges when molding with respect to melt viscosity, temperature stability, tensile strength, and impact resistance. Therefore there continues to be a desire for improved extrudable compositions that are more environmentally friendly, i.e., are derived from renewable resources and are biodegradable, and overcome the challenges relating to molding articles from such compositions, particularly compositions including PLA.

### SUMMARY OF THE INVENTION

To this end, the present invention provides an extrudable composition comprising cyclodextrin and polylactic acid, (PLA) coated with a natural oil (e.g., a plant-based oil), fatty acid, wax or waxy ester. The present invention also provides a method of forming molding articles from such an extrudable composition including the steps of coating the PLA with the natural oil, fatty acid, wax or waxy ester, mixing the coated PLA with the cyclodextrin, drying the mixture to remove substantially all of any moisture, extruding the dried mixture, and molding the extruded composition into an article of manufacture.

Thus, in an aspect of the invention, provided is an extrudable composition having a heat deflection temperature of greater than about 50° C. and a melting point between about 80° C. to about 190° C., wherein the extrudable composition comprises:

a) about 60 to about 99.8% partially crystalline or crystalline polylactic acid;

b) about 0.05 to about 8% cyclodextrin;

c) about 0.1 to about 8% natural oil, natural wax;

d) about 0.01 to about 5% nanofibers;

e) about 0 to about 10% crystallinity agent;

f) about 0 to about 1% starch-based melt rheology modifier;

g) about 0 to about 5% colorant;

h) about 0 to about 1% plasticizer;

i) about 0 to about 1% gloss agent; and

j) about 0 to about 1% barrier agent.

In another aspect of the invention, provided is a container formed from an extrudable composition derived from renewable resources, the extrudable composition comprising PLA and cyclodextrin coated with a natural oil, fatty acid ester, a wax or waxy ester, nanofibers, a crystallinity agent, a starch-based rheology modifier and a colorant.

In still another aspect of the invention, provided is a closure for a container formed from an extrudable composition comprising PLA, a cyclodextrin coated with a natural oil, fatty acid ester, a wax or a waxy ester, a crystallinity agent, a crystallinity retarder and a colorant.

In still another aspect of the invention, provided is a cap or a lid formed from an extrudable composition comprising PLA and cyclodextrin coated with a natural oil, fatty acid ester, a wax or waxy ester, a crystallinity agent, a crystallinity retarder, a colorant and optionally nanofibers.

In still another aspect of the invention, provided is a method of forming molded articles comprising coating PLA with a natural oil, fatty acid, fatty acid ester, wax and/or waxy ester, mixing the coated PLA with cyclodextrin, drying the mixture to a moisture level of less than 0.2% of water, extruding the dried mixture and molding the extruded composition into an article of manufacture.

### BRIEF DESCRIPTION OF THE DRAWINGS

FIG. 1 is a DSC chart corresponding to Example 1.

FIG. 2 is a DSC chart corresponding to Example 2.

FIG. 3 is a DSC chart corresponding to Example 3.

FIG. 4 is a DSC chart corresponding to Comparative Example 1.

FIG. 5 is a DSC chart corresponding to Comparative Example 2,

FIG. 6 is a DSC chart corresponding to Comparative Example 3.

FIG. 7 is a DSC chart corresponding to Comparative Example 4.

FIG. 8 is a DSC chart corresponding to Examples 4-6 and Comparative Example 7.

FIG. 9 is a DSC chart corresponding to Examples 10-13.

FIG. 10 depicts DSC charts corresponding to Examples 14 and 16 and Comparative Example 6 and Comparative Example 8.

### DETAILED DESCRIPTION OF EMBODIMENTS OF THE INVENTION

The foregoing and other aspects of the present invention will now be described in more detail with respect to the description and methodologies provided herein. It should be appreciated that the invention may be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. When a range is employed (e.g., a range from x to y) it is it meant that the measurable value is a range from about x to about y, or any range therein, such as about x₁ to about y₁, etc. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

It will be understood that although the terms “first,” “second,” “third,” “a),” “b),” and “c),” etc. may be used herein to describe various elements of the invention should not necessarily be limited by these terms. These terms are only used to distinguish one element of the invention from another. Thus, a first element discussed below could be termed a element aspect, and similarly, a third without departing from the teachings of the present invention. Thus, the terms “first,” “second,” “third,” “a),” “b),” and “c),” etc, are not intended to necessarily convey a sequence or other hierarchy to the associated elements but are used for identification purposes only. The sequence of operations (or steps) is not necessarily limited to the order presented in the claims and/or drawings unless specifically indicated otherwise.

All patents, patent applications and publications referred to herein are incorporated by reference in their entirety. In the event of conflicting terminology, the present specification is controlling.

The embodiments described in one aspect of the present invention are not limited to the aspect described. The embodiments may also be applied to a different aspect of the invention as long as the embodiments do not prevent these aspects of the invention from operating for its intended purpose.

As discussed above, the present invention provides an extrudable composition comprising cyclodextrin and polylactic acid (PLA) coated with a natural oil, fatty acid or wax. In one embodiment, the extrudable composition may also include a carboxylic acid or alkyl ester plasticizer. In another embodiment, the extrudable composition may include nanofibers. In yet another embodiment, the extrudable composition may include a crystallinity agent or a crystallinity retarder. In another embodiment, the extrudable composition may include a rheology modifier. In another embodiment, the extrudable composition may include a colorant, and often a naturally-derived colorant. In another embodiment, the extrudable composition may include gloss agent. In yet another embodiment, the extrudable composition may include a barrier agent. Various combinations of these embodiments are also contemplated by the present invention.

The extrudable composition of the invention may be formulated so as to substantially mimic the properties of non-biodegradable convention polymers derived from non-renewable resources such as polyethylene terephthalate (PET), high density polyethylene (HDPE), polyethylene (PE), and polypropylene (PP). Specifically the present invention provides extrudable compositions having heat deflection or heat distortion (HDT) melt viscosity, temperature stability, and impact resistance comparable to conventional polymers.

In general, the PLA may be derived from lactic acid. Lactic acid may be produced commercially by fermentation of agricultural products such as whey, corn starch, potatoes, molasses, sugar cane, and the like. Typically, the PLA polymer is formed by first forming a lactide monomer by the depolymerization of a lactic acid oligomer. This monomer may then be subjected to ring-opening polymerization of the monomer. For purposes of this disclosure, the term ‘lactide-based polymer’ is intended to by synonymous with the terms polylactide, polylactic acid (PLA) and polylactide polymer, and is intended to include any polymer formed via the ring opening polymerization of lactide monomers, either alone (i.e., homopolymer) or in mixture or copolymer with other monomers. The term is also intended to encompass any different configuration and arrangement of the constituent monomers (such as syndiotactic, isotactic, and the like). The lactide-based polymer may or may not be derived from a renewable resource.

The lactide monomer may be polymerized in the presence of a suitable polymerization catalyst, at elevated heat and pressure conditions, as is generally known in the art. The catalyst may be any compound or composition that is known to catalyze the polymerization of lactide. Such catalysts are well known, and include alkyl lithium salts and the like, stannous octoate, aluminum isopropoxide, and certain rare earth metal compounds as described in U.S. Pat. No. 5,028,667. The particular amount of catalyst used may vary generally depending on the catalytic activity of the material, as well as the temperature of the process and the polymerization rate desired. Typical catalyst concentrations include molar ratios of lactide to catalyst of between about 10:1 and about 100,000:1, and in one embodiment from about 2,000:1 to about 10,000:1. According to one exemplary process, a catalyst may be distributed in a starting lactide monomer material. If a solid, the catalyst may have a relatively small particle size. In one embodiment, a catalyst may be added to a monomer solution as a dilute solution in an inert solvent, thereby facilitating handling of the catalyst and its even mixing throughout the monomer solution. In those embodiments in which the catalyst is a toxic material, the process may also include steps to remove catalyst from the mixture following the polymerization reaction, for instance one or more leaching steps.

In one embodiment, a polymerization process may be carried out at elevated temperature, for example, between about 95° C. and about 200° C., or in one embodiment between about 110° C. and about 170° C., and in another embodiment between about 140° C. and about 160° C. The temperature may generally be selected so as to obtain a reasonable polymerization rate for the particular catalyst used while keeping the temperature low enough to avoid polymer decomposition. In one embodiment, polymerization may take place at elevated pressure, as is generally known in the art. The process typically takes between about 1 and about 72 hours, for example between about 1 and about 4 hours.

The molecular weight of the degradable polymer should be sufficiently high to enable entanglement between polymer molecules and yet low enough to be melt processed. For melt processing, PLA polymers or copolymers have weight average molecular weights of from about 10,000 g/mol to about 600,000 g/mol, preferably below about 500,000 g/mol or about 400,000 g/mol, more preferably from about 50,000 g/mol to about 300,000 g/mol or about 30,000 g/mol to about 400,000 g/mol, and most preferably from about 100,000 g/mol to about 250,000 g/mol, or from about 50,000 g/mol to about 200,000 g/mol. When using PLA, it is preferred that the PLA is in the semi-crystalline or partially crystalline form. To form semi-crystalline PLA, it is preferred that at least about 90 mole percent of the repeating units in the polylactide be one of either L- or D-lactide, and even more preferred at least about 95 mole percent. The processing may be conducted in such a way that facilitates crystalline formation, for example, using extensive orientation. Alternatively amorphous PLA may be blended with a PLA having a higher degree of crystallinity. Alternatively, crystallinity agents as described below may be added to make amorphous PLA more crystalline and/or to adjust the levels of amorphous PLA and crystalline PLA when both are used.

Polylactide homopolymer obtainable from commercial sources may also be utilized in forming the disclosed polymeric composite materials. For example, poly(L-lactic acid) available from Polysciences, Inc, Natureworks, LLC, Cargill, Inc., Mitsui (Japan), Shimadzu (Japan), Chronopol or Synbra Technologies (Netherlands) may be utilized in the disclosed methods. The PLA polymer may have a melting point sufficiently low for processability but high enough for thermal stability. Thus the melting point may be between about 80° C. to about 190° C., and in some embodiments is between about 150° C. to about 180° C.

The PLA may be copolymerized with one or more other polymeric materials. In one embodiment, the lactide-based copolymer may be copolymerized with one or more other monomers or oligomers derived from a renewable resource. Thus in one embodiment the lactide-based copolymer may be a PLA polymer or copolymer and polyhydroxy alkanoate (PHA). PHA is rapidly environmentally degradable but often does not have the processability of PLA. PHA may be derived by the bacterial fermentation of sugars or lipids. Exemplary PHAs are described in U.S. Pat. No. 6,808,795 B2. A commercially available PHA is Nodax™ from Proctor & Gamble.

In another embodiment, the PLA may be copolymerized with other polymers or copolymers which may or may not be biodegradable. Such polymers or copolymers may include polypropylene (PP), aromatic/aliphatic polyesters, aliphatic polyesteramide polymers, polycaprolactones, polyesters, polyurethanes derived from aliphatic polyols, polyamides, polyethylene terephthalate (PET), polystyrene (PS), polyvinylchloride (PVC), and cellulose esters either in biodegradable form or not.

In addition to the PLA described above, the extrudable composition includes cyclodextrin. Cyclodextrin (CD) is cyclic oligomers of glucose which typically contain 6, 7, or 8 glucose monomers joined by α-1,4 linkages. These oligomers are commonly called α-cyclodextrin (α-CD), β-cyclodextrin (β-CD, or BCD), and γ-cyclodextrin (γ-CD), respectively. Higher oligomers containing up to 12 glucose monomers are known but their preparation is more difficult. Each glucose unit has three hydroxyls available at the 2, 3, and 6 positions. Hence, α-CD has 18 hydroxyls or 18 substitution sites available and may have a maximum degree of substitution (DS) of 18. Similarly, β-CD and γ-CD have a maximum DS of 21 and 24 respectively. The DS is often expressed as the average DS, which is the number of substituents divided by the number of glucose monomers in the cyclodextrin. For example, a fully acylated β-CD would have a DS of 21 or an average DS of 3. In terms of nomenclature, this derivative is named heptakis(2,3,6-tri-O-acetyl)-β-cyclodextrin which is typically shortened to triacetyl-β-cyclodextrin.

The production of CD involves first treating starch with an α-amylase to partially lower the molecular weight of the starch followed by treatment with an enzyme known as cyclodextrin glucosyl transferase which forms the cyclic structure. Topologically, CD may be represented as a toroid in which the primary hydroxyls are located on the smaller circumference and the secondary hydroxyls are located on the larger circumference. Because of this arrangement, the interior of the torus is hydrophobic while the exterior is sufficiently hydrophilic to allow the CD to be dissolved in water. This difference between the interior and exterior faces allows the CD or selected CD derivatives to act as a host molecule and to form inclusion complexes with hydrophobic guest molecules provided the guest molecule is of the proper size to fit in the cavity.

Thus PLA may be the guest molecule. However, cyclodextrins, particularly BCD, are not soluble in PLA resin thus there may be poor dispersion. One known solution is to use organic solvents to aid dispersion. The use of such organic solvents, however, is not desirable in that these solvents, e.g., toluene, methylene chloride, etc., are not environmentally friendly.

It has been discovered that dispersion may be unexpectedly improved by the addition of a natural oil, fatty acid, fatty acid ester, wax or waxy ester to the PLA prior to mixing or blending the PLA and CD together. In one embodiment, the natural oil, fatty acid, fatty acid ester, wax or waxy ester is coated on the PLA (e.g., PLA pellets) pellets using agitation. Without being bound to one theory, it is believed the hydrophilic coating of the natural oil, fatty acid, wax or waxy ester is included first into the center of the CD and oil, fatty acid, wax or waxy ester pulls the PLA into the center of the CD thereby facilitating extrusion of the composition. A blend or mixture of the natural oil, fatty acid, wax or waxy ester may be used.

In an embodiment, the extrudable composition may include a natural oil. Suitable natural oils include lard, beef tallow, fish oil, coffee oil, soy bean oil, safflower oil, tung oil, tall oil, calendula, rapeseed oil, peanut oil, linseed oil, sesame oil, grape seed oil, olive oil, jojoba oil, dehydrated castor oil, tallow oil, sunflower oil, cottonseed oil, corn oil, canola oil, orange oil, and mixtures thereof. In operation, shaped particles or additives to be introduced into the PLA polymer should preferably be coated with at least one of the above oils and heated to about 160° F. to about 180° F. for a period of about 4 to about 12 hours. This will substantially saturate the particle or additive with the oil. In this manner after a particle or additive is saturated with oil in the presence of heat, the particle may be substantially included into the PLA polymer matrix.

Suitable waxes include naturally-derived waxes and waxy esters may include without limitation, bees wax, plant-based waxes, bird waxes, non-bee insect waxes, and microbial waxes. Waxy esters also may be used. As utilized herein, the term ‘waxy esters’ generally refers to esters of long-chain fatty alcohols with long-chain fatty acids. Chain lengths of the fatty alcohol and fatty acid components of a waxy ester may vary, though in general, a waxy ester may include greater than about 20 carbons total. Waxy esters may generally exhibit a higher melting point than that of fats and oils. For instance, waxy esters may generally exhibit a melting point greater than about 45° C. Additionally, waxy esters encompassed herein include any waxy ester including saturated or unsaturated, branched or straight chained, and so forth. Waxes have been found to also facilitate increasing the Heat Deflect Temperature of the PLA films and to provide barrier properties, such as reduced Oxygen Transfer and Water Vapor Transfer.

Suitable fatty esters or fatty acid esters are the polymerized product of an unsaturated higher fatty acid reacted with an alcohol. Exemplary high fatty esters include oleic ester, linoleic ester, resinoleic ester, lauric ester, myristic ester, stearic ester, palmitic ester, eicosanoic ester, eleacostearic ester, and the like, and mixtures thereof.

These esters may be combined with suitable oils, as well as various esters derived from carboxylic acids may be included to act as plasticizers for the PLA. Exemplary carboxylic acids include acetic, citric, tartaric, lactic, formic, oxalic and benzoic acid. Furthermore these acids may be reacted with ethanol to make an acid ethyl ester, such as ethyl acetate, ethyl lactate, monoethyl citrate, diethyl citrate, triethyl citrate (TEC). Most naturally occurring fats and oils are the fatty acid esters of glycerol.

In another embodiment, the extrudable composition may include nanofibers. Suitable nanofibers include fibers derived from silica and have a diameter of about 1 μm or less using a SEM measurement and typically have a length of about 65 to about 650 nm. Suitable nanofibers are available from Johns Manville as Micro-Stand™ 106-475, Alternatively nanofibers derived from treated (refined) cellulose may be used. For example, wood pulp could be treated with a natural oil and wherein the pulp and oil may be mechanically refined in a pulp type refiner to develop fibrils which causes the solution to form a gel. Biodegradable wood fibers such as bleached or unbleached hardwood and softwood kraft pulps may be used as the pulp, High fiber count northern hardwoods such as Aspen and tropical hardwoods such as eucalyptus are of particular interest. Also nonwood fibers may be used such as flax, hemp, esparato, cotton, kenaf, bamboo, abaca, rice straw, or other fibers derived from plants. Alternatively a renewable and biodegradable source of cellulose fibers, particularly those having a microfiber structure, for example, switch grass may be used. Although Applicants do not wish to be bound by any one theory, it is believed that the nanofibers contribute to the crystallinity of the PLA thus facilitating the use of amorphous PLA and also contributing to improved physical properties of the extrudable composition when either amorphous and/or partially crystalline PLA are utilized.

In another embodiment, the extrudable composition may include a crystallinity agent and wherein the polymer may be in the form of platelet-like crystals. Examples of crystallinity agents include, but are not limited to talc, kaolin, mica, bentonite clay, calcium carbonate, titanium dioxide and aluminum oxide.

In another embodiment, the extrudable composition may include a starch-based melt rheology modifier. Suitable starches are those produced by plants and include cereal grains (corn, rice, sorghum, etc.), potatoes, arrowroot, tapioca and sweet potato. In operation, these plant-based starches tend to gel when combined with PLA and can be used to provide a smooth surface to the molded article.

In another embodiment, the extrudable composition may include one or more crystallinity retarders. Examples of crystallinity retarders include, but are not limited to, xanthan gum, guar gum, and locust bean gum.

In another embodiment colorants to provide the common colors associated with pharmaceutical and nutraceutical containers, i.e., white, amber, and green, may be included. In an embodiment wherein a white container is desired, titanium dioxide may be included preferably with safflower oil as the natural oil. Typically the amount of colorant present is 0 to 67% depending on the type of extruder used, and may preferably be about 0.1 to 3% based on the overall weight of the extrudable composition. In an embodiment wherein a green container is desired, sodium copper chlorohyllin or a food grade analine powder available from DDW The Color House, may be used as the colorant. In an embodiment wherein an amber container is desired, a blend of 0.019 to 0.021% food grade black, 0.008 to 0.010% blue, 0.104 to 0.106% red, and 0.063 to 0.065% yellow colorants available from Keystone, Chicago, Ill. may be used.

Agents to provide additional water and oxygen barrier properties may be included. Exemplary water and oxygen barrier agents include candelilla wax, beeswax, and other waxes. Preferably such a barrier agent is derived from a renewable source.

Gloss agents to provide an aesthetically pleasing gloss to the container may be included. Exemplary gloss agents include shea butter and nut oils such as Brazil nut oil. Preferably such a gloss agent is derived from a renewable source.

Other additives may include other natural or synthetic plasticizers such as lignins, impact modifiers, fiber reinforcement other than nanofibers, antioxidants, antimicrobials, fillers, UV stabilizers, glass transition temperature modifiers, melt temperature modifiers and heat deflection temperature modifiers. Of particular interest as fillers are biodegradable nonwood fibers such as those used for the nanofibers, and include kenaf, cotton, flax, esparto, hemp, abaca or various fiberous herbs.

In general, the extrudable composition may comprise an extrudable composition having a heat deflection temperature greater than about 50° C. and a melting point between about 80° C. to about 190° C., the extrudable composition comprises, a) about 0 to about 100% amorphous PLA; b) about 0 to about 100% partially crystalline or crystalline PLA; c) about 0.1 to about 8% natural oil or natural wax; d) about 0.01 to about 5% nanofibers; e) about 0.05 to about 8% BCD; e) about 0 to about 10% crystallinity agent; f) about 0 to about 1% starch-based melt rheology modifier; g) about 0 to about 1% polysaccharide crystallinity retarder; h) about 0 to about 5% colorant; i) about 0 to about 1% plasticizer; j) about 0 to about 1% gloss agent; and k) about 0 to about 1% barrier agent. In an embodiment of the invention, the extrudable composition may comprise greater than about 85%, 86%, 87%, 88%, 89%, 90%, 91%, 92%, 93%, 94%, 95%, 96%, 97% 98% or about 99% amorphous or crystalline PLA. In another embodiment of the invention, the extrudable composition may comprise a mixture of amorphous and crystalline PLA. In still another embodiment, BCD is present in the extrudable composition in an amount of about 0.05%, 0.4%, 1%, 2%, 3%, 4%, 5%, 6%, 7%, or up to about 8% BCD. In yet another embodiment, the natural oil or natural wax is present in the extrudable composition in an amount of about 0.1%, 0.25%, 0.5%, 0.75%, 1%, 1,5%, 2%, 3%, 4%, 5%, 6%, 7%, or up to about 8% natural oil. In a further embodiment, the nanofibers are present in an amount of about 0.1%, 0.2%, 0.25%, 0.3%, 0.4%, 0.5%, 0.75%, 1%, 2%, 3%, 4% or up to about 5% nanofibers. In still a further embodiment, the crystallinity agent is optionally present in the extrudable composition in an amount of about 1%, 2%, 3%, 4%, 5%, 6%, 7%, 8%, 9%, up to about 10% crystallinity agent. In yet another embodiment, the starch-based melt rheology modifier is optionally present in the extrudable composition in an amount of about 0.1%, 0.2%, 0.3%, 0.4%, 0.5%, 0.6%, 0.7%, 0.8%, 0.9%, up to about 1% starch-based melt rheology modifier. In still another embodiment, the polysaccharide crystallinity retarder is optionally present in an amount of about 0.1%, 0.2%, 0.3%, 0.4%, 0.5%, 0.6%, 0.7%, 0.8%, 0.9%, up to about 1% polysaccharide crystallinity retarder. In still a further embodiment, the colorant is optionally present in the extrudable composition in an amount of about 0.1%, 0.2%, 0.3%, 0.4%, 0.5%, 0.6%, 0.7%, 0.8%, 0.9%, up to about 1% colorant. In still a further embodiment, the plasticizer is optionally present in the extrudable composition in an amount of about 0.1%, 0.2%, 0.3%, 0.4%, 0.5%, 0.6%, 0.7%, 0.8%, 0.9%, up to about 1% plasticizer. In still a further embodiment, the gloss agent is optionally present in the extrudable composition in an amount of about 0.1%, 0.2%, 0.3%, 0.4%, 0.5%, 0.6%, 0.7%, 0.8%, 0.9%, up to about 1% gloss agent. In still a further embodiment, the barrier agent is optionally present in the extrudable composition in an amount of about 0.1%, 0.2%, 0.3%, 0.4%, 0.5%, 0.6%, 0.7%, 0.8%, 0.9%, up to about 1% barrier agent.

Prior to extrusion, the extrudable composition is dried to remove substantially all of the moisture, i.e., there is less than about 0.02% water, and often less than about 0.01% water. Typically, desiccant drying is utilized.

In one embodiment master batch is used. By utilizing a master batch, the often more expensive additives may be first compounded in larger percentage amounts into the master batch and then added to 100% PLA. Such use of a master batch may be used to incorporate additives more cost effectively, for example, those that improve properties like barrier properties, flexibility properties, HDT properties, and the like. Another example is that a master batch may be formulated so that the consumer has the capability of customizing the color of the article of manufacture. For example, some amount of the base colorant (e.g., green colorant) may be added to pure PLA, then the colorant/PLA composition and the master batch with smaller amounts of the green colorant(s) are combined to result in the end extrudable composition having the desired color. The smaller amounts of green colorant(s) in the master batch may be selected to arrive at the desired hue or shade of the desired color.

For illustrative purposes, an extrudable composition for a closure or cap having properties similar to an HPDE closure or cap may be made. A master batch comprising crystalline PLA, natural oil coated on the PLA, nanofibers, cyclodextrin, crystallinity agent, pigment and a crystallinity retarder is formed by coating the PLA with the oil, adding the crystallinity agent and blending with BCD and combining with the rest of the constituents.

The extrudable composition may then be formed into an article of manufacture. For example, the process may include extrusion molding, injection molding or blow molding the composition in melted form. For purposes of the present disclosure, injection molding processes include any molding process in which a polymeric melt or a monomeric or oligomeric solution is forced under pressure, for instance with a ram injector or a reciprocating screw, into a mold where it is shaped and cured. Blow molding processes may include any method in which a polymer may be shaped with the use of a fluid and then cured to form a product. Blow molding processes may include extrusion blow molding, injection blow molding, and stretch blow molding, as desired. Extrusion molding methods include those in which a melt is extruded from a die under pressure and cured to form the final product, e.g., a film or a fiber. Single screw or double screw extruders may be used, the selection of which and the amounts of each component being varied depending on the extruder will be within the skill of one in the art.

In one embodiment, the molded article is a container. The term “container” as used in this specification and the appended claims is intended to include, but is not limited to, any article, receptacle, or vessel utilized for storing, dispensing, packaging, portioning, or shipping various types of products or objects (including but not limited to, food and beverage products). Specific examples of such containers include boxes, cups, “clam shells”, jars, bottles, plates, bowls, cutlery, trays, cartons, cases, crates, cereal boxes, frozen food boxes, milk cartons, carriers for beverage containers, dishes, egg cartons, lids, straws, envelopes, stacks, bags, baggies, or other types of holders. Containment products and other products used in conjunction with containers are also intended to be included within the term “container.”

In a further embodiment, the extrudable composition as disclosed herein may be formed as a container, and in one particular embodiment, a container suitable for holding and protecting environmentally sensitive materials such as biologically active materials including pharmaceuticals and nutraceuticals. For purposes of the present disclosure, the term ‘pharmaceutical’ is herein defined to encompass materials regulated by the United States government including, for example, drugs and other biologics. For purposes of the present disclosure, the term ‘nutraceutical’ is herein defined to refer to biologically active agents that are not necessarily regulated by the United States government including, for example, vitamins, dietary supplements, and the like.

In yet another embodiment, the molded article is a containment product that is a closure. The term “closure” as used in the specification and the appended claims is intended to include, but is not limited to, any containment product such as caps, lids, liners, partitions, wrappers, films, cushioning materials, utensils, and any other product used in packaging, storing, shipping, portioning, serving, or dispensing an object within a container. Examples of closures include, but are not limited to, screw caps, snap on caps, tamper-resistant, tamper-evident and child-resistant closures or caps.

For illustrative purposes, an extrudable composition for a container having properties similar to a PET container may be made. A master batch comprising partially crystalline or crystalline PLA, a natural oil, nanofibers, cyclodextrin, pigment, and a crystallinity agent is formed by mixing the oil and nanofibers, adding the oil and nanofibers to the PLA with the other constituents, then combining with a mixture of cyclodextrin and starch crystallinity retarder, followed by an addition of a crystallinity agent and then agitation and drying. A colorant/pigment may be added to the master batch. Alternatively, a separate batch of crystalline PLA and pigment may be made and the master batch and this separate batch then fed together.

An exemplary formulation for a container may comprise about 70 to about 95% crystalline polylactic acid, about 0.05 to about 8% cyclodextrin, about 0.1 to about 8% natural oil or wax, about 0.01 to about 5% nanofibers, about 0.01 to about 10% crystallinity agent, about 0.01 to about 1% starch-based rheology modifier, and about 0.01 to about 8% colorant.

Another illustration example, is an extrudable composition for a closure or a cap for a container or a bottle having properties similar to HDPE may be made. An exemplary formulation for a cap may comprise about 70 to about 95% crystalline polylactic acid, about 0.05 to about 8% cyclodextrin, about 0.1 to about 8% natural oil or wax, about 0.01 to about 10% crystallinity agent, about 0.01 to about 1% crystallinity retarder, about 0.01 to about 8% colorant, and optionally nanofibers.

Formed articles and structures incorporating the extrudable composition may include laminates including the disclosed composite materials as one or more layers of the laminate. For example, a laminate structure may include one or more layers formed of composite materials as herein described so as to provide particular inhibitory agents at predetermined locations in the laminate structure. Barrier properties may also be increased by using a wax coating inside or outside of the vessel being utilized for spraying or dipping.

Alternatively the various extrusion, blow molding, injection molding, casting or melt processes known to those skilled in the art may be used to form films or sheets. Exemplary articles of manufacture include articles used to wrap, or otherwise package food or various other solid articles. The films or sheets may have a wide variety of thicknesses, and other properties such as stiffness, breathability, temperature stability and the like which may be changed based on the desired end product and article to be packaged. Exemplary techniques for providing films or sheets are described, for example, in U.S. Patent Publication Nos. 2005/0112352, 2005/0182196, and 2007/0116909, and U.S. Pat. No. 6,291,597, the disclosures of which are incorporated herein by reference in their entireties.

In an exemplary embodiment, a laminate may include an impermeable polymeric layer on a surface of the structure, e.g., on the interior surface of a container (e.g., bottle or jar) or package (e.g., blister pack for pills). In one particular embodiment, an extruded film formed from the extrudable composition may form one or more layers of such a laminate structure. For example, an impermeable PLA-based film may form an interior layer of a container so as to, for instance, prevent leakage, degradation or evaporation of liquids that may be stored in the container. Such an embodiment may be particularly useful when considering the storage of alcohol-based liquids, for instance, nutraceuticals in the form of alcohol-based extracts or tinctures.

The following examples will serve to further exemplify the nature of the invention but should not be construed as a limitation on the scope thereof, which is defined by the appended claims.

### EXAMPLES

To demonstrate the improved properties of coating the PLA with a natural oil prior to mixing with the BCD, Examples 1-3 were carried out.

### Example 1

An extrudable composition comprising 91.5% PLA, 7% BCD, and 1.5% jojoba oil is formed. If BDC and PLA merely mixed, the BCD will be poorly dispersed and not soluble in the melted PLA during extrusion. Thus, jojoba oil is agitated onto the PLA and then the BCD is added to the coated PLA and agitated again. The composition is heated to 160° F. to 180° F. for a period of 4 to 12 hours to totally saturate the BCD with oil so that the BCD particles will be fully included into the PLA polymer matrix. The resulting composition is then extruded as a film which is uniformly with no flakes.

### Example 2

An extrudable composition comprising 90.5% crystalline PLA, 7% BCD, 1.5% jojoba oil, and a plasticizer 0.1% triethylcitrate (TEC) is formed, wherein the jojoba oil and TEC are agitated onto the PLA and then the BCD is added to the PLA and agitated again. The composition is heated to 160° F. to 180° F. for a period of 4 to 12 hours to totally saturate the BCD with oil and TEC so that the BCD particles will be fully included into the PLA polymer matrix. The resulting composition is then extruded as a film.

### Example 3

An extrudable composition comprising 91.5% crystalline PLA, 7% BCD, and 1.5% olive oil is formed, wherein the olive oil is agitated onto the PLA and then the BCD is added to the PLA and agitated again. The composition is heated to 160° F. to 180° F. for a period of 4 to 12 hours to totally saturate the BCD with oil so that the BCD particles will be fully included into the PLA polymer matrix. The resulting composition is then extruded as a film.

### Comparative Example 1

A 100% polyester (PE) composition is formed and is extruded as a film.

### Comparative Example 2

A 100% polypropylene (PP) composition is formed and is extruded as a film.

### Comparative Example 3

A PLA composition comprising amorphous PLA, jojoba oil, turmeric, and cotton flock is formed and is extruded as a film.

### Comparative Example 4

A PLA composition comprising amorphous PLA, jojoba oil, turmeric, and cotton flock is formed with use of a desiccant dryer and is extruded as a film.

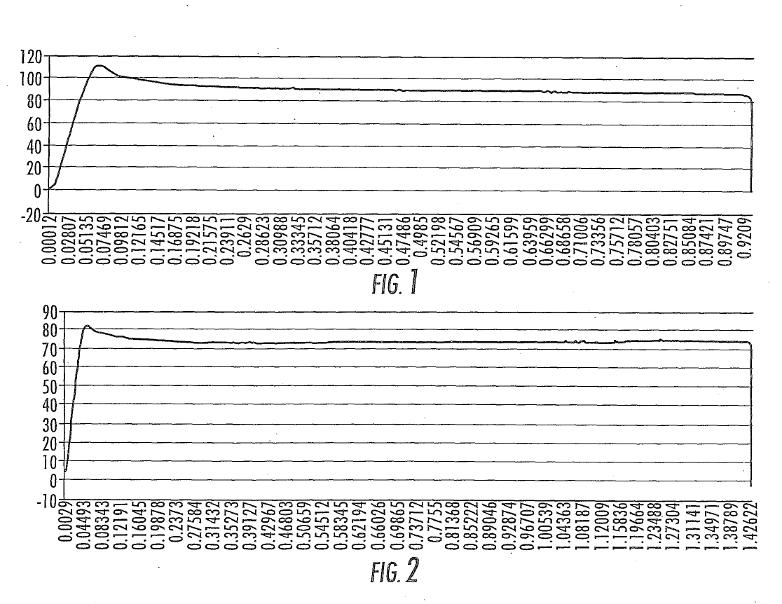

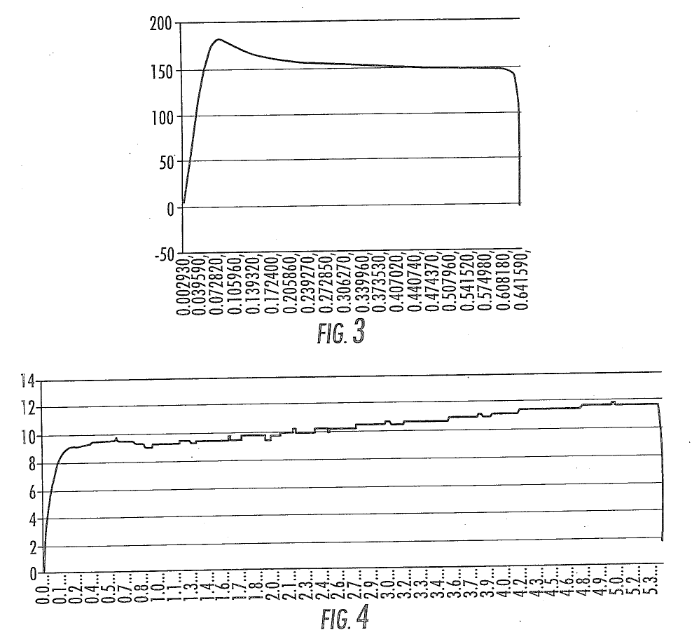

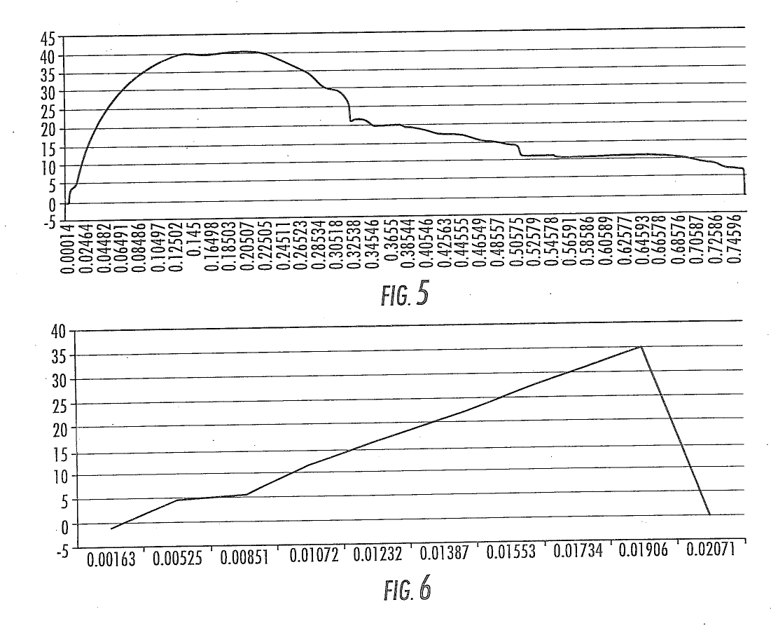

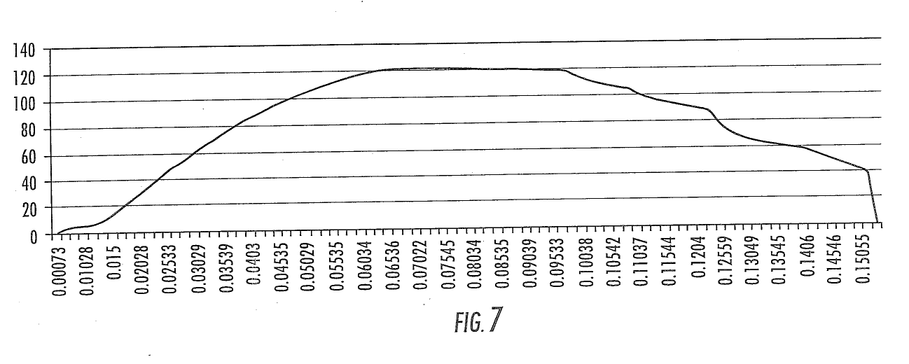

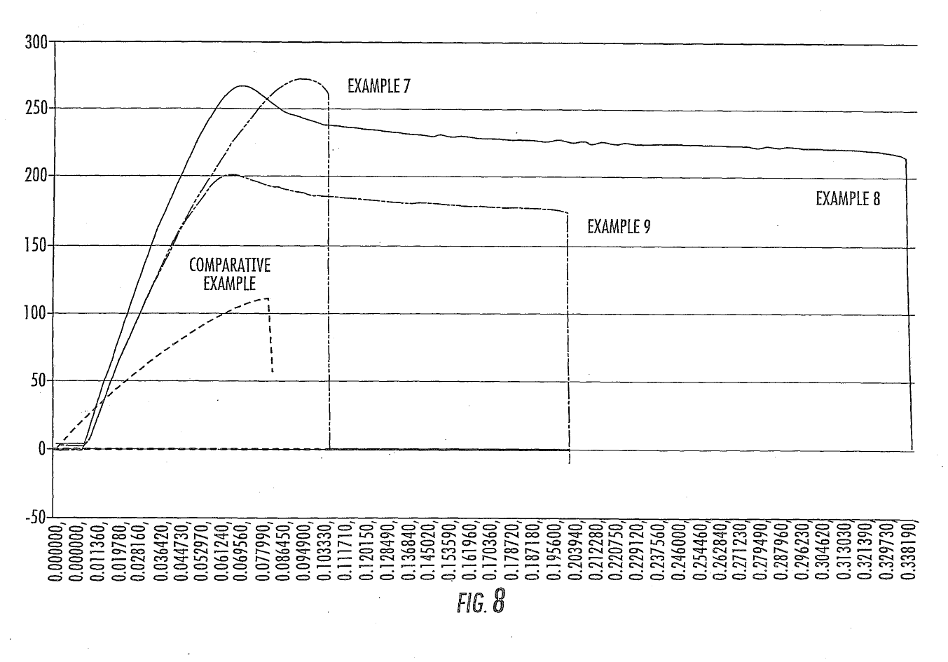

Results of stress/strain data for Examples 1-3 and Comparative Examples 1-4 are provided in Table 1, results of DSC data for Examples 1-3 are provided in FIGS. 1-3 and results for DSC data for Comparative Examples 1-4 are provided in FIGS. 4-7. Table 1 and FIGS. 1-7 demonstrate that an extrudable composition of the invention including PLA, BCD, and a natural oil, fatty acid, wax or waxy ester (Examples 1-3), have improved elongation and toughness, % strain and energy at break and thermal resistance as compared to conventional polymers such as PE (Comparative Example 1) and PP (Comparative Example 2) and as compared as to known PLA formulations not including BCD and a natural oil, fatty acid, wax or waxy ester coated on the PLA (Comparative Examples 3 and 4); moreover, no harsh solvents were necessary without adversely affecting physical properties.

TABLE 1

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Young's | 223 | 284 | 330 | 15 | 115 | 206 | 241 |
| Modulus (Ksi) | | | | | | | |
| Stress at Yield | 3539 | 4250 | 5520 | 288 | 1712 | 0 | 3556 |
| (Psi) | | | | | | | |
| Ultimate Tensile | 3899 | 4542 | 6206 | 923 | 3096 | 1250 | 4519 |
| Strength (Psi) | | | | | | | |
| % Strain at | 7.5 | 2.1 | 6.0 | 253 | 9 | 0.6 | 3 |
| Peak | | | | | | | |
| % Strain at | 45.9 | 71 | 18.7 | 274 | 25 | 0.36 | 6.9 |
| Break | | | | | | | |
| Energy at Break | 82.5 | 104 | 51 | 56 | 13 | <1 | 12 |
| (lbf-in) | | | | | | | |
| Tg Onset (° C.) | 59.7 | 56.7 | 57.8 | | 36.7 | 52.8 | 57.4 |
| Tg Midpoint | 61.2 | 57.8 | 59.5 | | 39.9 | 55.0 | 59.1 |
| (° C.) | | | | | | | |
| T Melt (° C.) | 151.5 | 151.7 | 157.9 | 104.6 | 169.2 | 157.2 | 153.0 |
| T | 116.6 | 117.2 | 117.7 | | | 102.0 | 118.7 |
| Crystallization | | | | | | | |
| (° C.) | | | | | | | |

### Example 4

An extrudable composition comprising 95.6% amorphous PLA, 0.4% nanosilica fibers, and 4.0% white pigment is suitably combined, dried, formed and extruded as a film.

### Example 5

An extrudable composition comprising 91.0% crystalline PLA, 4.0% mica, 1.0% jojoba oil applied to the PLA, and 4.1% white pigment is suitably combined, dried, formed and extruded as a film.

### Example 6

An extrudable composition comprising a mixture of 50% of Example 4 and 50% of Example 5 is suitably combined, dried, formed and extruded as a film.

### Comparative Example 5

A 100% amorphous PLA is extruded as a film.

### Comparative Example 6

A 100% crystalline PLA is extruded as a film.

### Comparative Example 7

A 100% polyester is extruded as a film.

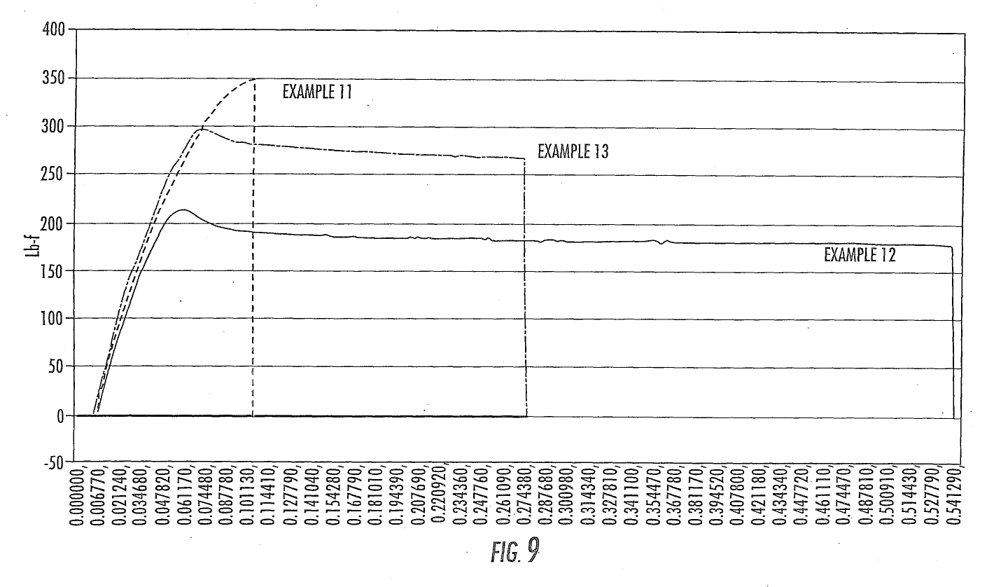

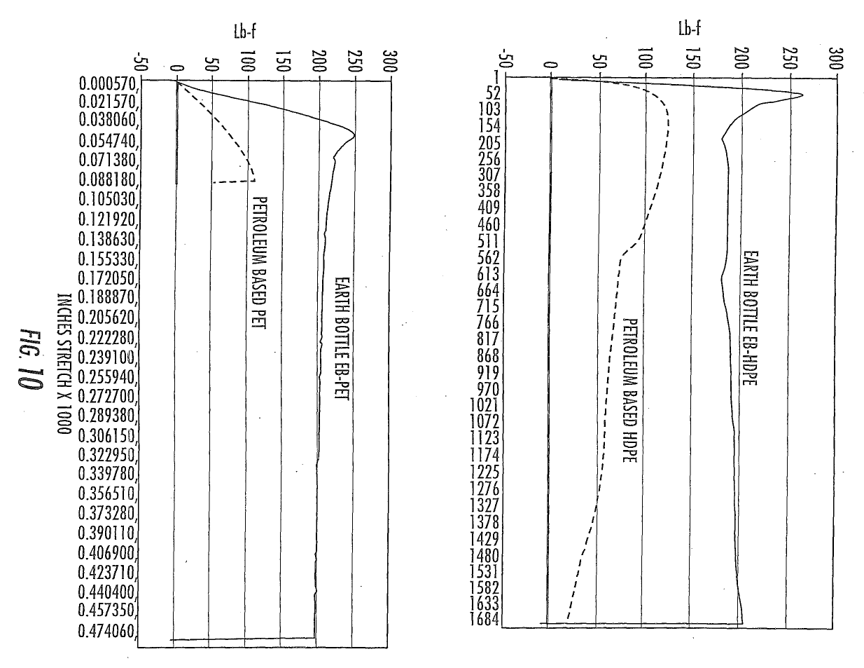

The results of stress/strain data for Examples 4-6 and Comparative Examples 5-7 are provided in Table 2 and the results of DSC data for Examples 4-6 and Comparative Example 7 are provided in FIG. 8. The results demonstrate that an extrudable composition of the invention including PLA, BCD, nanofibers and/or a natural oil (Examples 4-6) provided improved elongation, % strain and energy at break and thermal resistance as compared to 100% PLA (Comparative Examples 5 and 6) or conventional polyester (Comparative Example 7).

TABLE 2

| | Comparative | Comparative | Comparative | | | |
|---|---|---|---|---|---|---|
| | Example 5 | Example 6 | Example 7 | Example 4 | Example 5 | Example 6 |
| Young's | 297 | 236 | 269 | 330 | 306 | 357 |
| Modulus (Ksi) | | | | | | |
| Stress at Break | 5717 | 5097 | 6857 | 9607 | 4013 | 6776 |
| (Psi) | | | | | | |
| Stress at | 6580 | 5611 | 7413 | 9680 | 6363 | 7144 |
| Peak (Psi) | | | | | | |
| % Strain at | 3.4 | 3.2 | 3.9 | 4.0 | 5.7 | 6.0 |
| Peak | | | | | | |
| % Strain at | 4.4 | 3.1 | 3.9 | 3.9 | 16.0 | 10.1 |
| Break | | | | | | |
| Energy at Break | 6.5 | 3.8 | 5.7 | 12.8 | 28.8 | 36.6 |
| (lbf-in) | | | | | | |
| Tg Onset (° C.) | 60.1 | 58.1 | 70.0 | 56.0 | 54.0 | 55.5 |
| Tg Midpoint | 61.0 | 60.5 | 73.0 | 62.0 | 61.0 | 61.0 |
| (° C.) | | | | | | |
| T | NA | 118.1 | 133.4 | 113.1 | 99.4 | 110.0 |
| Crystallization | | | | | | |
| (° C.) | | | | | | |
| T Melt (° C.) | 165 | 153.9 | 247.0 | 169.6 | 168.6 | 168.8 |
| Heat Deflection | 53.9 | 51.0 | 65.0 | 60.5 | 58.6 | 60.8 |
| Temp. (HDT) | | | | | | |
| (° C.) | | | | | | |
| Heat Deflection | 55.8 | 56.2 | 69.0 | 63.8 | 61.8 | 64.5 |
| Temp. (HDT) | | | | | | |
| (° C.) | | | | | | |

The use of a lower amount of nanofibers is demonstrated in Examples 7 and 10,

### Example 7

An extrudable composition comprising a blend of one part of 95.5% PLA, with 3% BCD and 1.5% jojoba oil is prepared as previously described, that is blended with an equal part of 99.5% amorphous PLA with 0.5% nanosilica fibers, is suitably combined, dried and is extruded as a film.

### Example 8

An extrudable composition comprising 98.4% crystalline PLA, 1,5% jojoba oil and 0.1% nanosilica fibers is suitably combined, dried and formed as previously described and is extruded as a film.

### Example 9

An extrudable composition comprising 99.9% amorphous PLA and 0.1% nanosilica fibers is suitably combined, dried and formed and is extruded as a film.

### Example 10

An extrudable composition comprising a mixture of one part of 95.5% crystalline PLA, 3% BCD and 1.5% jojoba oil, and one part of 95.75% crystalline PLA and 0.25% nanosilica fibers, and 4% white pigment is suitably combined, dried, and formed and is extruded as a film.

The results of stress/strain data for Examples 7-10 are provided in Table 3.

TABLE 3

| | Example 7 | Example 8 | Example 9 | Example 10 |
|---|---|---|---|---|
| Young's | 280 | 301 | 273 | 319 |
| Modulus (Ksi) | | | | |
| Stress at | 6841 | 6782 | 7127 | 5376 |
| Break (Psi) | | | | |
| Stress at | 4497 | 2103 | 6195 | 6244 |
| Peak(Psi) | | | | |
| % Strain | 6.4 | 5.9 | 7.1 | 6.3 |
| at Peak | | | | |
| % Strain | 15.6 | 44.9 | 10.6 | 29.3 |
| at Break | | | | |
| Energy at | 56.8 | 67.0 | 50.2 | 106.2 |
| Break (lbf-in) | | | | |
| Tg Onset | 54.0 | 58.0 | 53.0 | 57.0 |
| (° C.) | | | | |
| Tg Midpoint | 60.1 | 59.8 | 56.0 | 61.0 |
| (° C.) | | | | |
| T Crystallization | 110.9 | 115.2 | 106.0 | 113.2 |
| (° C.) | | | | |
| T Melt (° C.) | 163.9 | 153.2 | 168.7 | 150.5 |
| Heat Deflection | 55.0 | 52.6 | 57.8 | 54.8 |
| Temp. (HDT) | | | | |
| (° C.) | | | | |

The use of lower amounts of nanofibers is demonstrated in Examples 11-13.

### Example 11

An extrudable composition comprising 97.8% amorphous PLA, 0.2% nanosilica fibers, and 2% white pigment is suitably combined, dried and formed and extruded as a film.

### Example 12

An extrudable composition comprising 94.7% amorphous PLA, 0.3% nanosilica fibers, 1.0% mica, and 4.0% white pigment is suitably combined, dried and formed and extruded as a film.

### Example 13

An extrudable composition comprising 92.15% amorphous PLA, 0.75% jojoba oil, 0.1% nanosilica fibers, 3.0% mica, and 4.0% white pigment is suitably combined, dried and formed and extruded as a film.

The results of stress/strain data for Examples 11-13 are provided in Table 4 and the results of DSC data are provided in FIG. 10.

TABLE 4

| | Example 11 | Example 12 | Example 13 |
|---|---|---|---|
| Young's | 312 | 313 | 346 |
| Modulus (Ksi) | | | |
| Stress at | 9840 | 8430 | 6515 |
| Break (Psi) | | | |
| Stress at | 9850 | 8742 | 6902 |
| Peak(Psi) | | | |
| % Strain | 4.8 | 5.1 | 5.7 |
| at Peak | | | |
| % Strain | 4.7 | 10.5 | 22.4 |
| at Break | | | |
| Energy at | 20.7 | 40.5 | 31.7 |
| Break (lbf-in) | | | |
| Tg Onset | 56.5 | 60.0 | 55.0 |
| (° C.) | | | |
| Tg Midpoint | 61.0 | 63.0 | 61.0 |
| (° C.) | | | |
| T Crystallization | 116.4 | 109.0 | 102.7 |
| (° C.) | | | |
| T Melt (° C.) | 169.5 | 168.1 | 168.0 |
| Heat Deflection | 62.7 | 66.3 | 67.0 |
| Temp. (HDT) | | | |
| (° C.) | | | |

### Example 14

To demonstrate an extrudable composition mimicking PET for a container an extrudable composition is formed by forming a master batch by adding jojoba oil to crystalline PLA, agitating on 0.5% nanosilica, 2.0% BCD, 1.0% arrowroot and 20.0% mica and drying. 20% green pigment from PolyOne with 80% is added to master batch in a ribbon mixer. To this is added 100% crystalline PLA. The final overall composition is:

| | |
|---|---|
| 89.7% | crystalline PLA |
| 0.4% | BCD |
| 1.6% | jojoba oil |
| 0.1% | nanosilica fibers |
| 4.0% | mica |
| 0.2% | arrowroot |
| 4.0% | green pigment |

### Example 15

To demonstrate an extrudable composition mimicking HDPE for a bottle cap is formed as previously described and the final overall composition is:

| | |
|---|---|
| 88.5% | crystalline PLA |
| 1.0% | BCD |
| 3.0% | safflower oil |
| 0.1% | nanosilica fibers |
| 2.0% | mica |
| 0.2% | xanthan gum |
| 5.0% | white pigment |
| 0.2% | TEC |

The stress/strain data for Examples 14 and 15 as compared to Comparative Example 6 (100% PLA) and Comparative Example 8 (100% HDPE) are shown in Table 5. DSC data for Example 14 (Earth Bottle EB-PET) compared to Comparative Example 6 and DSC data for Example 15 (Earth Bottle EB-HDPE) compared to Comparative Example 8 are shown in FIG. 10.

TABLE 5

| | | Comparative | | Comparative |
|---|---|---|---|---|
| | Example 14 | Example 6 | Example 15 | Example 8 |
| Young's | 351 | 269 | 274 | 163 |
| Modulus (Ksi) | | | | |
| Stress at | 5527 | 6857 | 5624 | 1313 |
| Break (Psi) | | | | |
| Stress at | 6159 | 7413 | 5636 | 3864 |
| Peak(Psi) | | | | |
| % Strain | 4.0 | 3.9 | 6.2 | 15.9 |
| at Peak | | | | |
| % Strain | 28.6 | 3.9 | 144.6 | 100.6 |
| at Break | | | | |
| Energy at | 106.1 | 5.7 | 549.6 | 164.5 |
| Break (lbf-in) | | | | |
| Tg Onset | 51.0 | 70.0 | 49.0 | NA |
| (° C.) | | | | |
| Tg Midpoint | 58.0 | 73.0 | 58.0 | NA |
| (° C.) | | | | |
| T | 115.0 | 133.4 | 108.7 | NA |
| Crystallization | | | | |
| (° C.) | | | | |
| T Melt (° C.) | 154.6 | 247.0 | 155.2 | 134.3 |
| Heat Deflection | 67 | 70.0 | 62.0 | 72.1 |
| Temp. (HDT) | | | | |
| (° C.) | | | | |
| Oxygen | 28.55 | 2.97 | 28.55 | 20.71 |
| Transfer | | | | |
| Rate (OTR) | | | | |
| Water Vapor | 8.89 | 8.10 | 8.89 | 0.63 |
| Transfer | | | | |
| Rate (WVTR) | | | | |

### Example 16

To demonstrate an extrudable composition having a white color for a container, an extrudable composition is formed by forming a master batch by adding 4.8% safflower oil and 0.4% shea butter gloss agent together and then adding the 0.4% nanosilica. This is then agitated on 59.6% crystalline PLA followed by agitation with 1.6% BCD, 24% TiO₂ colorant, 0.8% arrowroot, 8% mica, 0.4% candelilla wax (barrier agent), and dried. The master batch is combined with 50% TiO₂ colorant and 50% 100% crystalline PLA. The final overall composition is:

| | |
|---|---|
| 92.9% | crystalline PLA |
| 0.4% | BCD |
| 1.2% | safflower oil |
| 0.1% | nanosilica fibers |
| 2.0% | mica |
| 0.2% | arrowroot |
| 3.0% | TiO₂ colorant |
| 0.1% | shea butter gloss agent |
| 0.1% | candelilla barrier agent |

### Example 17

To demonstrate an extrudable composition having an amber color for a container, an extrudable composition is formed by forming a master batch by adding 6.0% jojoba oil and 0.5% shea butter gloss agent together and then adding 0.5% nanosilica. This is then agitated on 78.7% crystalline PLA followed by agitation with 2.0% BCD, 1.0% amber colorant (0.040 g black, 0.018 g blue, 0.210 g red, and 0.160 yellow), 1.0% arrowroot, 10.0% mica, and 0.5% candelilla wax barrier agent, and dried. This is combined with 24% amber colorant and 76% 100% crystalline PLA. The final overall composition is:

| | |
|---|---|
| 95.7% | crystalline PLA |
| 0.4% | BCD |
| 1.2% | jojoba oil |
| 0.1% | nanosilica fibers |
| 2.0% | mica |
| 0.2% | arrowroot |
| 0.2% | amber colorant |
| 0.1% | shea butter gloss agent |
| 0.1% | candelilla barrier agent |

### Example 18

To demonstrate an extrudable composition having a green color for a container, an extrudable composition is formed by forming a master batch by adding 6.0% jojoba oil and 0.5% shea butter gloss agent together and then adding 0.5% nanosilica, his is then agitated on 78.0% 100% crystalline PLA followed by agitation with 2.0% BCD, 1.5% chlorophyllin colorant, 1.0% arrowroot, 10.0% mica, and 0.5% candelilla wax barrier agent, and dried. The master batch is combined with 24% chlorophyllin colorant and 76% 100% crystalline PLA. The final overall composition is:

| | |
|---|---|
| 95.6% | crystalline PLA |
| 1.2% | jojoba oil |
| 0.1% | nanosilica fibers |
| 0.4% | BCD |
| 2.0% | mica |
| 0.2% | arrowroot |
| 0.3% | chlorophyllin colorant |
| 0.1% | shea butter gloss agent |
| 0.1% | candelilla barrier agent |

### Examples 14a and 14b

To demonstrate the barrier properties of an extrudable composition, the composition of Example 14, except for the percentage of mica (14a and 14b), was extruded into a bottle having varying amounts of mica. The Oxygen Transfer Rate (OTR) and Water Vapor Transfer Rate (WVTR) were measured. The results are provided in Tables 6 and 7.

TABLE 6

| | | Bottle Wall | |
|---|---|---|---|
| Example | % Mica | Thickness (mm) | OTR Average |
| Pure PLA Control | 0 | 1.02 | 29.01 |
| 14a | 2 | 0.85 | 28.55 |
| 14 | 4 | 0.81 | 24.36 |
| 14b | 8 | 10.51 | 15.98 |

The observed Oxygen Transfer Rates exhibited by the bottles prepared from the compositions of Examples 19-22 are comparable to PET and HDPE.

TABLE 7

| | | Bottle Wall | |
|---|---|---|---|
| Example | % Mica | Thickness (mm) | WVTR Average |
| Pure PLA Control | 0 | 1.02 | 11.15 |
| 14a | 2 | 0.85 | 8.89 |
| 14 | 4 | 0.81 | 8.04 |
| 14b | 8 | 10.51 | 5.35 |

The observed Water Vapor Transfer Rates exhibited by the bottles prepared from the compositions of Examples 23-26 are comparable to PET.

To demonstrate the barrier properties of an extrudable composition, the composition of pure PLA is compared to Example 14a containing 2% mica and Example 18 which contains 2% Mica and Candelilla Wax. The Water Vapor Transfer Rate (WVTR) was measured. The results are provided in Table 8.

TABLE 8

| | % Mica/ | Bottle Wall | |
|---|---|---|---|
| Example | Candelilla Wax | Thickness (mm) | WVTR Average |
| Pure PLA Control | 0/No | 1.02 | 11.15 |
| Example 14a | 2/No | 0.85 | 8.89 |
| Example 18 | 2/Yes | 1.22 | 7.32 |

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1.-62. (canceled)

63. An extrudable composition having a heat deflection temperature of greater than about 50° C. and a melting point between about 80° C. to 190° C., wherein the extrudable composition comprises:
a) about 60 to about 99.8% partially crystalline or crystalline polylactic acid;
b) about 0.05 to about 8% cyclodextrin;
c) about 0.1 to about 8% natural oil, fatty acid, fatty acid ester, wax or waxy ester;
d) about 0.01 to about 5% nanofibers;
e) about 0 to about 10% crystallinity agent;
f) about 0 to about 1% starch-based melt rheology modifier;
g) about 0 to about 5% colorant;
h) about 0 to about 1% plasticizer;
i) about 0 to about 1% gloss agent; and
j) about 0 to about 1% barrier agent.

64. The extrudable composition of claim 63, wherein the cyclodextrin is β-cyclodextrin.

65. The extrudable composition of claim 63, wherein the natural oil is selected from the group consisting of lard, beef tallow, fish oil, coffee oil, coconut oil, soy bean oil, safflower oil, tung oil, tall oil, calendula, rapeseed oil, peanut oil, linseed oil, sesame oil, grape seed oil, olive oil, jojoba oil, dehydrated castor oil, tallow oil, sunflower oil, cottonseed oil, corn oil, canola oil, orange oil, and mixtures thereof.

66. The extrudable composition of claim 63, wherein the nanofibers are derived from fibers of silica or cellulose.

67. The extrudable composition of claim 63, wherein the crystallinity agent is selected from the group consisting of mica, kaolin, clay, talc, calcium carbonate, aluminum oxide and mixtures thereof.

68. The extrudable composition of claim 63, wherein the moisture level is less than about 0.02% of water.

69. An article of manufacture formed from the extrudable composition of claim 63.

70. The article of manufacture of claim 69, wherein the article of manufacture is selected from the group consisting of a container, bottle, lid, cap, closure, container, package and canister.

71. A container or a closure for a container formed from an extrudable composition derived from a renewable resource comprising:
a) about 70 to 95% crystalline polylactic acid;
b) about 0.05 to 8% cyclodextrin;
c) about 0.1 to 8% natural oil, fatty acid, fatty acid ester, wax or waxy ester;
d) about 0.01 to 5% nanofibers;
e) about 0.01 to 10% crystallinity agent;
f) about 0.01 to 1% starch-based melt rheology modifier; or
g) about 0.01 to 8% colorant.

72. The container or closure of claim 71, wherein the cyclodextrin is β-cyclodextrin.

73. The container or closure of claim 72, wherein the natural oil is selected from the group consisting of lard, beef tallow, fish oil, coffee oil, coconut oil, soy bean oil, safflower oil, tung oil, tall oil, calendula, rapeseed oil, peanut oil, linseed oil, sesame oil, grape seed oil, olive oil, jojoba oil, dehydrated castor oil, tallow oil, sunflower oil, cottonseed oil, corn oil, canola oil, orange oil, and mixtures thereof.

74. The container or closure of claim 71, wherein the nanofibers are derived from fibers of silica or cellulose.

75. The container or closure of claim 71, wherein the crystallinity agent is selected from the group consisting of mica, kaolin, clay, talc, calcium carbonate, aluminum oxide and mixtures thereof.

76. The container or closure of claim 71, wherein the moisture level is less than about 0.02% of water.

77. The container or closure of claim 71, wherein the starch-based melt rheology modifier is arrowroot.

78. The container or closure of claim 71, wherein the extrudable composition further comprises candelilla wax or shea butter or both.

79. A method of forming molded articles comprising coating PLA with a natural oil, fatty acid, fatty acid ester, wax or waxy ester, and/or an alkyl ester plasticizer, mixing the coated PLA with cyclodextrin, drying the mixture to a moisture level of less than 0.2% of water, extruding the dried mixture and molding the extruded composition into an article of manufacture.

80. The method of claim 79, wherein the composition is heated to about 160° F. to about 180° F. for a period of about 4 to about 12 hours to substantially saturate the nanofiber, cyclodextrin, crystallinity agents, starch-based melt rheology modifier, and polysaccharide crystallinity retarder, with oil so that the cyclodextrin is substantially included into the PLA polymer matrix.

81. The method of claim 79, wherein the article is molded using extrusion molding, injection molding or blow molding.

82. The method of claim 79, wherein the cyclodextrin is β-cyclodextrin.

83. The method of claim 79, wherein the PLA is selected from the group consisting of lard, beef tallow, fish oil, coffee oil, coconut oil, soy bean oil, safflower oil, tung oil, tall oil, calendula, rapeseed oil, peanut oil, linseed oil, sesame oil, grape seed oil, olive oil, jojoba oil, dehydrated castor oil, tallow oil, sunflower oil, cottonseed oil, corn oil, canola oil, orange oil, and mixtures thereof.

84. The method of claim 79, wherein the mixture further includes nanofibers, a crystallinity agent, a starch-based melt rheology modifier, a polysaccharide crystallinity retarder and/or a pigment.
